(19) United States
(12) Patent Application Publication
(10) Pub. No.: US 2025/0375875 A1
(43) Pub. Date: Dec. 11, 2025

(54) MODULAR ROBOTIC POD SYSTEM

(71) Applicant: Lorenzo Juncaj, Sterling Heights, MI (US)

(72) Inventor: Lorenzo Juncaj, Sterling Heights, MI (US)

(21) Appl. No.: 19/302,383

(22) Filed: Aug. 18, 2025

(51) Int. Cl. B25J 9/08; B25J 9/00; B25J 9/12; B25J 9/16

(52) U.S. Cl. CPC B25J 9/08; B25J 9/0009; B25J 9/126; B25J 9/1682

(57) ABSTRACT

The invention relates to a modular robotic pod system, which is configured to house one or more dual-arm robots within a compact, reconfigurable work cell. Each robot is mounted on a base translatable along a primary linear rail defining an X-axis, with actuators providing Y-axis and Z-axis motion and a rotational platform enabling 360° orientation. Upon rotation, the base selectively engages a secondary linear guide to continue travel along the X-axis, thereby achieving four-axis mobility without increasing footprint. A modular pod frame supports multiple spatial arrangements to match workspace constraints and robot density and permits rapid reconfiguration and use of interchangeable end effectors. The system integrates one or more pod-mounted cameras and a dedicated camera for each robot to provide visual monitoring, guidance, inspection, and collision avoidance in high-throughput industrial operations.

### FIELD OF THE INVENTION

The present invention relates generally to robotic automation systems and, more particularly, to configurable and adaptable robotic work cell architectures for use in industrial, manufacturing, and production environments.

### BACKGROUND

In modern manufacturing and industrial environments, the demand for increased automation has driven the adoption of robotic systems across a wide range of applications. While robotic integration has proven effective in enhancing productivity, reducing labor costs, and improving precision, many existing robotic systems are fixed in configuration and optimized for a single set of tasks. Such fixed layouts often lack flexibility, making them unsuitable for reconfiguration when production requirements change or when space constraints limit installation options. Conventional industrial robots typically require substantial floor space and dedicated infrastructure, restricting their integration into compact work areas or workstations originally designed for human operators. Moreover, the scalability of many existing robotic systems is limited, with significant time and cost investments needed to expand, relocate, or reconfigure these systems. This results in inefficiencies when adapting to fluctuating production demands, varying product types, or multi-step collaborative processes requiring multiple robots to operate in close proximity. Additionally, in environments where throughput and operational agility are critical, traditional robotic setups may fail to deliver the necessary combination of speed, versatility, and density of operation. There is, therefore, a need for an improved robotic system architecture that can be deployed in compact spaces, reconfigured to meet changing requirements, and scaled to accommodate varying numbers of robots, while maintaining or enhancing operational efficiency.

### BRIEF SUMMARY

The present invention provides a modular robotic pod system specifically designed to house and operate one or more dual-arm robots within a compact, reconfigurable, and high-performance robotic work cell. The system is engineered for seamless integration into existing workstations and production cells, including those originally intended for a single human operator, while significantly increasing throughput, task automation, and operational flexibility.

In one aspect, each robot is mounted on a base that travels along a primary linear rail defining an X-axis. The base incorporates actuators enabling motion along the Z-axis (vertical movement) and Y-axis (depth movement), thereby supporting three-dimensional positioning. Additionally, the base features a 360-degree rotational platform that allows the robot to orient itself in any direction. Following rotation, for example by ninety degrees, the base is capable of engaging a secondary linear guide that enables continued motion along the same X-axis infrastructure, effectively delivering four-axis capability without expanding the system's footprint.

In another aspect, the modular architecture of the pod frame supports dynamic configurations tailored to the operational layout and robot density requirements of a given environment. The system supports between one and four or more dual-arm robots within a single pod, with the robots configured to operate collaboratively on complex tasks. Each robot can be equipped with interchangeable end effectors, allowing the system to adapt quickly to task-specific requirements.

The modular robotic pod system comprises at least one pod frame configured to house one or more dual-arm robots. The modular robotic pod system further comprises at least one primary linear rail defining an X-axis. The modular robotic pod system further comprises at least one robot base mounted to the primary linear rail, the robot base including actuators configured to provide motion along a Y-axis and a Z-axis, and a rotational platform configured to rotate the dual-arm robot about 360 degrees. Upon rotation, the robot base is engageable with a secondary linear guide enabling continued motion along the X-axis. The pod frame is modular and reconfigurable to support multiple spatial configurations for accommodating varying numbers of robots within a compact workspace, for example, human-sized work cell or workstation.

In an embodiment, the pod frame is configurable in at least one of a linear configuration, vertically stacked configuration, side-by-side configuration, hybrid configuration, U-shaped configuration, dual-U-shaped configuration, or gantry-style configuration. These configurations allow deployment in diverse industrial and manufacturing spaces, from compact single-operator workstations to larger multi-operator cells. The system's flexibility enables robots to operate with optimal spatial efficiency, facilitating maximum throughput without compromising safety or accessibility. By combining multi-axis robot mobility, omnidirectional orientation, modular frame adaptability, and collaborative multi-robot operation within a compact form factor, the invention delivers a scalable, high-performance automation solution. This enables manufacturers to achieve higher operational density, reduced cycle times, and rapid reconfiguration for changing production needs, making the system suitable for deployment across a broad range of industries and workflows.

In an embodiment, the pod frame is expandable to increase robot density without increasing the overall footprint. In an embodiment, the robot base is configured to move along the primary linear rail while maintaining operational stability during motion. In an embodiment, the dual-arm robot includes interchangeable end effectors adapted for task-specific operations. In an embodiment, the secondary linear guide is aligned to permit uninterrupted motion of the robot base following rotation. In an embodiment, the pod frame and robots are arranged to enable collaborative operation between multiple robots within the same workspace.

The modular robotic pod system further comprises one or more cameras mounted to the pod frame for monitoring the workspace and robot operations. In an embodiment, each of the one or more dual-arm robots is integrated with a dedicated camera for task-specific visual guidance. In an embodiment, each dedicated camera is configured to provide real-time visual feedback to a control system for positioning and task execution. In an embodiment, the one or more cameras are configured to perform at least one of object recognition, quality inspection, or motion tracking within the workspace. In an embodiment, the cameras are configured to detect obstacles and dynamically adjust robot paths to prevent collisions. In an embodiment, the dedicated camera for each robot is mounted to provide a field of view encompassing both arms of the robot.

In an embodiment, the rotational platform is operable to rotate the dual-arm robot to predefined angular positions for task alignment. In an embodiment, the actuators are configured to provide synchronized X, Y, and Z-axis motion to coordinate multi-axis positioning. In an embodiment, the pod frame is designed to integrate into existing compact workstations or multi-operator production cells. In an embodiment, the primary linear rail and secondary linear guide share a common support structure to minimize floor space usage. In an embodiment, the system is configured for rapid reconfiguration to change the spatial arrangement of the robots without requiring substantial disassembly. In an embodiment, the dual-arm robots are configured to operate cooperatively on a single task or independently on separate tasks. In an embodiment, the pod frame is constructed from modular segments that are connectable in multiple orientations to form a desired pod geometry.

In some embodiments, the modular robotic pod system may further be distinguished by its highly flexible motion architecture, allowing deployment with any subset of its available motion axes. The motion axes include the X-axis for primary horizontal travel, the Y-axis for depth adjustment, the Z-axis for vertical positioning, a rotational axis for 360-degree orientation, and a secondary X-axis enabling extended travel after rotation. The system may be configured to operate with as few as two axes, such as X and Z for simple linear and vertical operations, or with three or four axes for more complex manipulation and reorientation requirements. In high-throughput or fully dynamic applications, all five axes may be enabled to provide complete spatial coverage and maximum task versatility. This axis configurability allows each pod to be tailored precisely to its intended use case, enabling cost optimization, adaptation to spatial constraints, and scalability for future operational upgrades without requiring structural redesign.

Further, lifting mechanisms for providing Z-axis and/or Y-axis motion may include telescopic lifts, scissor lifts, column lifts, or other equivalent designs capable of delivering controlled vertical or depth translation within the pod. These lifting mechanisms may be selected based on payload requirements, range of motion, available installation space, and stability considerations. The modular nature of the system allows any of these lift types to be integrated interchangeably, enabling the motion architecture to be optimized for the specific operational environment or application requirements.

### BRIEF DESCRIPTION OF THE ACCOMPANYING DRAWINGS

The novel features which are believed to be characteristic of the present invention, as to its structure, organization, use, and method of operation, together with further objectives and advantages thereof, will be better understood from the following drawings in which a presently preferred embodiment of the invention will now be illustrated by way of example. It is expressly understood, however, that the drawings are for the purpose of illustration and description only and are not intended as a definition of the limits of the invention. Embodiments of this invention will now be described by way of example in association with the accompanying drawings in which:

FIG. 1 illustrates a perspective view of a modular robotic pod system, in accordance with an embodiment of the present invention.

FIG. 2 illustrates an alternative perspective view of the modular robotic pod system, in accordance with an embodiment of the present invention.

FIG. 3 illustrates a dual-robot implementation of the modular robotic pod system, in accordance with an embodiment of the present invention.

FIG. 4 illustrates a high-density, multi-robot configuration of the modular robotic pod system, in accordance with an embodiment of the present invention.

FIGS. 5-8 illustrate exemplary real-world applications of the modular robotic pod system, in accordance with an embodiment of the present invention.

Further areas of applicability of the present invention will become apparent from the detailed description provided hereinafter. It should be understood that the detailed description of exemplary embodiments is intended for illustration purposes only and is, therefore, not intended to necessarily limit the scope of the invention.

### DETAILED DESCRIPTION

As used in the specification and claims, the singular forms “a”, “an”, and “the” may also include plural references. For example, the term “an article” may include a plurality of articles. Those with ordinary skill in the art will appreciate that the elements in the Figures are illustrated for simplicity and clarity and are not necessarily drawn to scale. For example, the dimensions of some of the elements in the Figures may be exaggerated, relative to other elements, to improve the understanding of the present invention. There may be additional components described in the foregoing application that are not depicted on one of the described drawings. In the event such a component is described, but not depicted in a drawing, the absence of such a drawing should not be considered as an omission of such design from the specification.

References to “one embodiment”, “an embodiment”, “another embodiment”, “yet another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

The words “comprising,” “having,” “containing,” and “including,” and other forms thereof, are intended to be equivalent in meaning and be open ended in that an item or items following any one of these words is not meant to be an exhaustive listing of such item or items or meant to be limited to only the listed item or items. Unless stated otherwise, terms such as “first” and “second” are used to arbitrarily distinguish between the elements. Thus, these terms are not necessarily intended to indicate temporal or other prioritization of such elements. While various exemplary embodiments of the disclosed invention have been described below it should be understood that they have been presented for purposes of example only, not limitations. It is not exhaustive and does not limit the invention to the precise form disclosed. Modifications and variations are possible considering the above teachings or may be acquired from practicing of the invention, without departing from the breadth or scope.

The present invention provides a modular robotic pod system. The modular robotic pod system comprises a pod frame configured to house one or more dual-arm robots. The pod frame provides the primary structural support for all motion and control components and is dimensioned to fit within compact work cells, including those originally designed for a single human operator. Its design enables the integration of multiple robots within the same footprint without compromising motion range or stability. The frame is constructed from modular segments that can be reoriented, expanded, or rearranged to match specific spatial layouts and task requirements, allowing rapid adaptation to existing or new production environments.

The system incorporates a primary linear rail defining the X-axis, which serves as the main horizontal translation axis for each robot base. This rail enables precise positioning along the pod length and is supported by precision ball screw or belt-driven actuators combined with linear guides for smooth, low-friction motion. The primary rail forms the backbone of the motion architecture, ensuring repeatable accuracy even under high-speed operation and heavy payload conditions. Each robot base mounted to the primary rail integrates actuators configured to provide motion along the Y-axis and Z-axis. The Y-axis motion (depth movement) enables the robot to reach into or out from the workspace, while the Z-axis motion (vertical movement) allows access to different height levels within the work cell. The lift systems providing these motions may include telescopic lifts, scissor lifts, column lifts, or other equivalent designs, with selection based on payload capacity, vertical range, and available space. This arrangement enables full 3D positioning of the robot within a constrained footprint. The robot base further comprises a 360-degree rotational platform that allows the dual-arm robot to reorient itself to any angular position. This rotational capability is essential for servicing multiple work zones without repositioning the entire pod or adding redundant rails. The rotational platform can move to predefined angular positions, such as 90°, 180°, or 270°, for rapid reorientation in repetitive tasks or can rotate freely for dynamic repositioning during multi-stage operations. Upon rotation, the robot base is configured to engage a secondary linear guide aligned with the existing X-axis infrastructure but oriented to enable continued travel in the rotated direction. This secondary guide system provides extended workspace coverage without increasing the overall footprint of the pod. By maintaining the same X-axis reference, the robot retains full three-axis capability in the rotated frame, effectively enabling four-axis mobility within a compact mechanical architecture.

The pod frame is modular and reconfigurable, supporting multiple spatial arrangements to optimize workspace utilization and robot density. Configurations may include linear arrangements along a single rail, vertically stacked rails for layered operation, side-by-side rails for back-to-back or adjacent work zones, hybrid arrangements combining vertical and horizontal stacking, and custom geometries such as U-shaped, dual-U, L-shaped, or gantry-style pods. Each configuration can be adapted to meet operational constraints, including spatial limitations, throughput goals, and human-robot interaction requirements.

The system supports collaborative operation between multiple dual-arm robots within the same pod. Each robot is capable of operating independently or in coordination with others to execute complex multi-stage tasks. Collaborative capabilities include shared kinematic awareness, synchronized motion planning, and coordinated end effector actions for passing, holding, or jointly manipulating objects. This functionality significantly increases throughput compared to single-robot or human-operated work cells.

The dual-arm robots are equipped with interchangeable end effectors to enable rapid adaptation to different task requirements. Supported tooling includes dexterous five-finger humanoid hands for human-like manipulation, adaptive three-finger grippers for irregular objects, parallel or dual grippers for high-speed handling, vacuum grippers for flat or smooth surfaces, magnetic grippers for ferrous materials, and custom-designed effectors for specialized operations. End effectors can be changed manually or via automatic tool changers integrated into the pod.

The system incorporates one or more cameras mounted to the pod frame for global workspace monitoring. These cameras provide high-level situational awareness, enabling functions such as object recognition, workflow tracking, safety monitoring, and collision avoidance with external objects or personnel. Each dual-arm robot is also integrated with a dedicated camera positioned between the arms or mounted directly to an end effector. These cameras deliver task-specific visual feedback, supporting precision manipulation, quality inspection, part alignment, and real-time trajectory correction. The camera systems may include RGB, depth, or stereo vision sensors depending on application requirements. The system includes vision-based functions for object recognition, quality inspection, and motion tracking. Vision data is processed by the onboard computing system to identify target objects, verify successful grasp or placement, detect defects, and track dynamic objects in the workspace. These capabilities enable adaptive and autonomous operation in dynamic industrial environments.

The rotational platform is operable to move to predefined angular positions for repeated tasks or to freely rotate for dynamic reorientation. This flexibility allows the robot to switch between distinct work zones without relocating the pod or requiring redundant motion systems. The system's actuators are configured for synchronized multi-axis motion control, allowing X, Y, Z, and rotational movements to be coordinated for smooth, collision-free trajectories. Integrated motor controllers and high-resolution encoders provide precise positional feedback, enabling accurate and repeatable motion even at high operating speeds. The modular pod is designed for integration into existing compact work cells or larger multi-operator production stations, allowing drop-in replacement of manual workflows with minimal infrastructure changes. The system maintains the footprint of a single human operator station while enabling multiple robots to work simultaneously in the same space, achieving throughput several times greater than a human performing equivalent tasks. The primary and secondary linear rails may share a common support structure, reducing weight, complexity, and installation footprint. This shared structure allows rapid transition between motion axes while maintaining alignment and precision. The pod frame and motion architecture allow for rapid reconfiguration without significant disassembly. Rail positions, lift mechanisms, and end effector stations can be repositioned or replaced to match new tasks or product designs. Multiple robots within the pod may operate cooperatively or independently. Cooperative operations include joint lifting, synchronized assembly, and object handoffs, while independent operation allows parallel task execution for higher throughput. The camera systems are configured for obstacle detection and collision avoidance, using depth sensing, motion tracking, and predictive path planning to prevent interference between robot arms, other robots, and surrounding equipment. The dedicated cameras for each robot are positioned to provide a field of view covering both arms, ensuring that manipulation and grasping operations are visually monitored for precision and safety. The pod frame is constructed from modular segments that can be connected in multiple orientations to create custom geometries. This allows integrators to adapt the system layout to unique workspace constraints, product flows, or operator preferences while maintaining compatibility with the core robotic and control systems.

The modular robotic pod system offers numerous advantages, including the ability to fit seamlessly into existing work cells or stations originally designed for a single human operator while accommodating multiple dual-arm robots within the same compact footprint, thereby delivering several times the throughput and operational speed of a human performing equivalent tasks. Its fully modular frame and motion architecture allow reconfiguration into linear, stacked, side-by-side, hybrid, or custom geometries to match spatial constraints and workflow requirements, with selectable two-to-five axis motion enabling cost optimization and task-specific deployment. The system supports interchangeable end effectors for rapid adaptation to varied operations, integrates advanced vision systems for precise manipulation, quality inspection, and collision avoidance, and enables cooperative multi-robot operation for complex, multi-stage processes. With synchronized multi-axis control, high-load lift mechanisms, scalable power options, and rapid reconfiguration capabilities, the system combines high performance, flexibility, and compactness to deliver superior automation efficiency across diverse industrial applications.

The invention will now be described with reference to the accompanying drawings which should be regarded as merely illustrative without restricting the scope and ambit of the present invention.

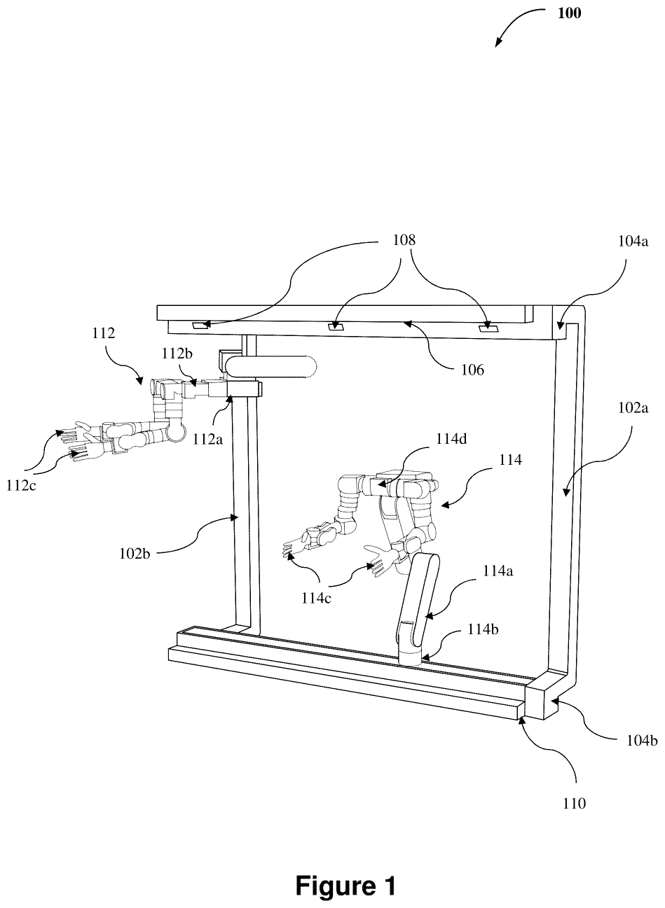

FIG. 1 illustrates a perspective view of a modular robotic pod system 100 designed for housing and operating one or more dual-arm robots 112, 114 within a compact, reconfigurable, and high-throughput work cell, for example, human-sized work cell or workstation. The illustration highlights various structural and functional components of the system, each of which contributes to its multi-axis motion, configurability, and visual intelligence. As shown, the system 100 comprises a modular pod frame 102a, 102b, which defines the structural boundaries of the work cell and serves as the support infrastructure for all mounted components. Along the top of the frame runs a linear actuator (x-axis) 104a, forming the primary rail along which the robot base is translated in the horizontal direction. Further, the robot base is coupled to the actuator 104a and further supported on a rotational base, which provides 360-degree rotational capability. This rotational base allows the robot 112 to reorient itself within the frame 102a, 102b and subsequently engage a secondary linear actuator (secondary x-axis) 112b. The dual-arm robot 114 is mounted above the rotational base 114b and supported by a scissor lift (z-axis) 114a, which facilitates vertical translation along the Z-axis. The robot 112, 114 is further equipped with a column lift (y-axis) 112a, 114a integrated into its support structure, enabling depth-wise motion along the Y-axis. Together, the x, y, z-axis motion and rotational capability offer full four-axis movement without increasing the system's footprint. Each arm 112c, 114c of the dual-arm robot 112, 114 terminates in end effectors, exemplified here by a 5-fingered robotic hand, which are interchangeable based on task requirements. The system integrates visual intelligence through pod-mounted cameras 108 affixed to the top frame, enabling overhead monitoring of the workspace. In addition, each dual-arm robot 112, 114 is equipped with cameras 114d between the arms, offering dedicated visual feedback for the robot's immediate task zone. These cameras 114d support functionalities such as object detection, precision alignment, quality inspection, and obstacle avoidance. The system also includes an onboard computer unit 106 mounted on the top frame, which serves as the local processing hub for coordinating robotic movements, sensor input, and task execution. A power input 110 is shown at the base of the frame 102a, providing electrical connectivity to the entire system, including actuators, lifts, processing units, and cameras.

In operation, the robot base travels laterally along the primary x-axis using the linear actuator, with the rotational base enabling directional reorientation. Upon rotation, the base aligns itself with the secondary linear actuator for continued motion along the alternate axis, effectively leveraging the same linear infrastructure to expand coverage area. The scissor lift raises or lowers the robot to reach different vertical work zones, while the column lift adjusts its forward or backward position along the Y-axis. The onboard cameras and vision system continuously monitor the workspace and the robot's arms to guide manipulation, positioning, and coordination between robots in multi-robot configurations. The modular pod frame permits adaptation into different geometries and scales, supporting a variety of industrial applications.

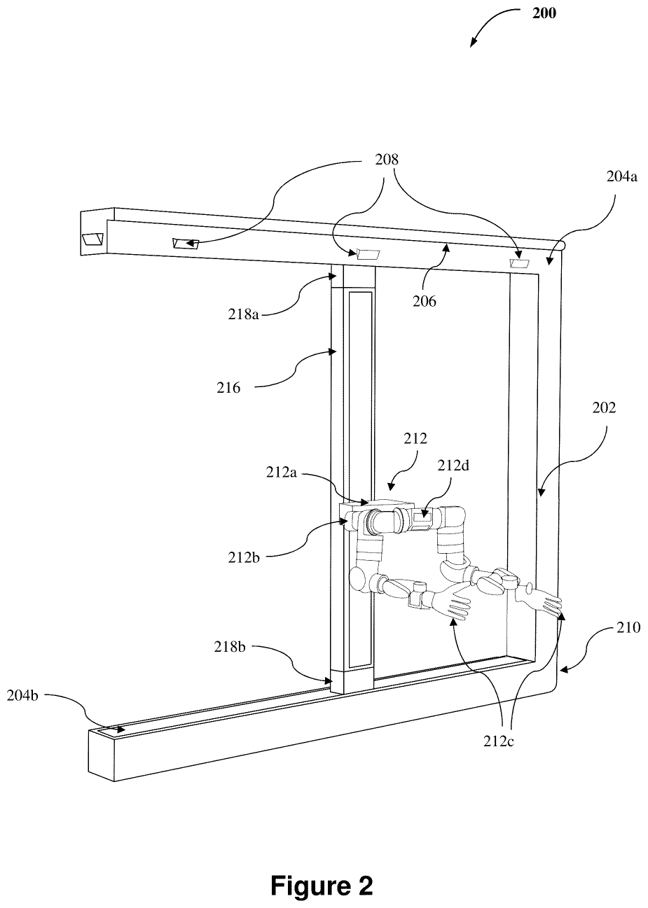

FIG. 2 illustrates an alternative perspective view of the modular robotic pod system 200, further highlighting the spatial arrangement and functional integration of its core components. This view emphasizes the vertical stacking, actuator placements, and camera positioning, offering clarity into how the multi-axis movement and sensing elements interact within the compact, modular frame. The system includes a modular pod frame 202, which forms the primary structure within which all robotic elements and actuators are mounted. The frame supports a linear actuator (x-axis) 204a, 204b that defines the primary horizontal travel path for the robot base. Rotational bases 218a, 218b are positioned on this x-axis actuator 204a, 204b, which allows the robot 212 to rotate a full 360 degrees to align with different work zones or secondary linear systems. Mounted atop the rotational base is a vertically oriented column lift (y-axis) 212a, enabling depth-wise motion of the robotic assembly 212 toward or away from the workspace. A linear actuator (secondary x-axis) 212b is integrated with the vertical lift column, allowing for lateral movement perpendicular to the primary X-axis after rotation. This secondary actuator 212b enables continued translational movement without increasing the system's footprint. A linear actuator (z-axis) 216 is also present, supporting vertical mobility of the robotic unit 212 to reach various elevation levels during operation. Mounted on this lift structure is the dual-arm robot 212, where each arm terminates in end effectors 212c configured as 5-fingered robotic hands for task-specific manipulation. The system integrates one or more cameras 212d between the robot arms, providing close-range, task-level visual feedback for operations such as precision grasping, part alignment, or inspection. Additional pod-mounted cameras 208 are positioned along the upper crossbar of the pod frame to enable at least one of overhead monitoring, object recognition, or workspace analysis. The system is controlled by an onboard computer unit 206 mounted adjacent to the top rail, responsible for processing input from sensors, coordinating robotic actions, and executing task sequences. A power input interface 210 is provided near the base of the frame, supplying electrical power to the entire system including actuators, cameras, processing units, and robot motors.

In operation, the dual-arm robot traverses horizontally along the X-axis via the primary linear actuator. When required, the rotational base reorients the robot assembly by a specified angle, such as 90 or 180 degrees, to engage with the secondary linear actuator aligned perpendicularly to the original axis. Vertical motion is achieved through the z-axis actuator, while forward and backward movement is handled by the y-axis column lift. The cameras provide continuous visual feedback for navigation, manipulation, and obstacle avoidance. Coordinated by the onboard computer, these motions enable the robot to perform complex, multi-step tasks in a confined space, with high accuracy and flexibility.

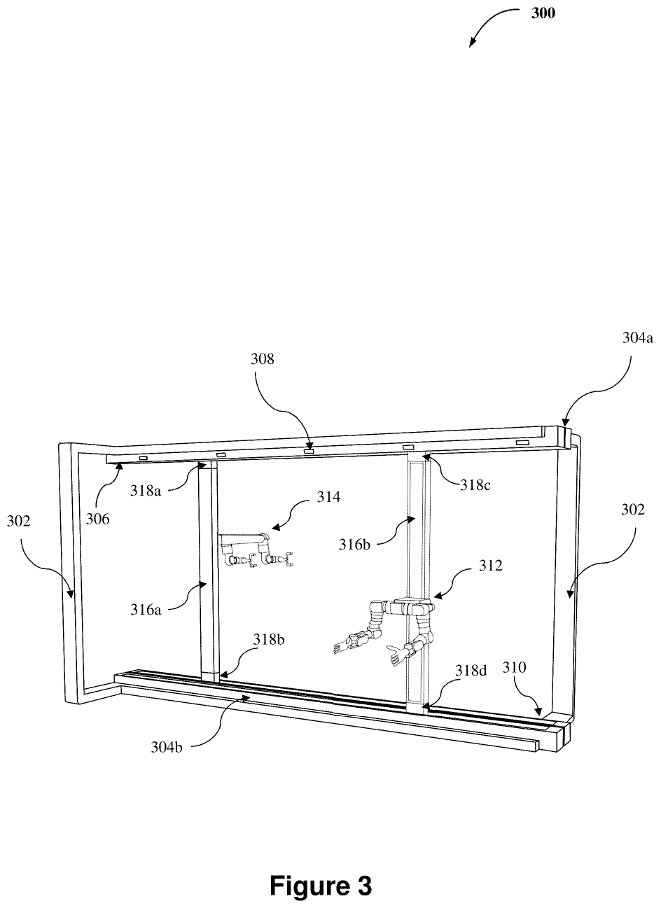

FIG. 3 illustrates a dual-robot implementation of the modular robotic pod system 300, emphasizing the simultaneous operation of two dual-arm robots 312, 314 within a shared modular frame. This view captures the spatial symmetry, multi-axis actuation capabilities, and collaborative layout designed to maximize throughput, task density, and workspace utilization within a compact footprint. The system is structured around a modular pod frame 302, which provides structural rigidity and serves as the mounting infrastructure for all robotic and electronic subsystems. Running horizontally is the linear actuator (x-axis) 304a, 304b, which defines the primary motion axis for both robot bases. Each robot base is mounted to the linear actuator 304a, 304b and further equipped with a rotational base 318a, 318b, 318c, 318d, enabling full 360-degree rotation for directional reorientation. This rotation allows the robot 312 to disengage from the primary axis and align with a linear actuator (secondary x-axis) mounted orthogonally, supporting continued lateral motion within the pod. Vertically aligned with each robot base is a column lift (y-axis), which enables fore-and-aft translational motion. Integrated with this column is a linear actuator (z-axis) that allows the robotic assembly to move vertically within the frame. Each lift assembly supports a dual-arm robot, which is equipped with task-specific end effectors, shown here as dual grippers. These grippers are interchangeable and reconfigurable to suit varied manipulation tasks such as assembly, handling, welding, or inspection. Positioned between the arms of each robot are cameras, which provide task-specific visual feedback for precision handling, part identification, and quality assurance. Additionally, the upper crossbar of the modular frame is fitted with pod-mounted cameras 308 that deliver overhead vision for workspace monitoring, coordination, and safety supervision. An onboard computer unit 306 mounted on the frame coordinates all motion control, visual processing, and data communication across the pod system. A power input 310 is located near the bottom of the frame, delivering electrical power to all actuators, motors, cameras, and processing units. The entire system is electrically and mechanically integrated to support seamless multi-robot collaboration.

In operation, each robot independently navigates the X-axis using the base-mounted linear actuator. Upon reaching a designated position, the rotational base enables reorientation, allowing either robot to engage a secondary x-axis actuator for cross-directional travel. The z-axis lift raises or lowers the robotic arms to access components at various heights, while the y-axis column lift adjusts depth positioning. The dual-arm configuration permits each robot to manipulate multiple objects or perform bimanual operations simultaneously. Vision input from both onboard and pod-mounted cameras ensures high-precision control, adaptive positioning, and real-time error correction.

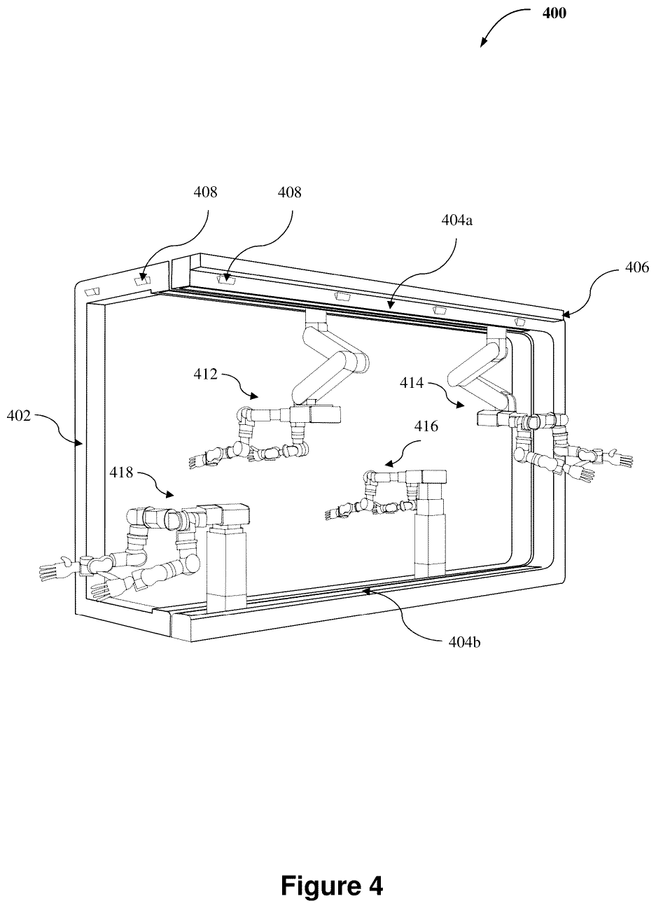

FIG. 4 illustrates a high-density, multi-robot configuration of the modular robotic pod system 400, showcasing three dual-arm robots operating within a single modular pod frame 402. This configuration demonstrates the system's scalability, reconfigurability, and capacity to accommodate multiple robots with full multi-axis motion within a compact footprint, while retaining individualized mobility and vision intelligence. The system is structured around the modular pod frame 402, which provides the mechanical foundation for mounting and supporting the components of all three robotic units 412, 414, 414, 416. Integrated along the top and bottom sections of the frame are dual linear actuators (x-axis) 404a, 404b, which define parallel primary rails for horizontally translating the robots along the X-axis. Each robot is mounted on an individual rotational base, which enables 360-degree rotational movement, allowing each robot to align itself for optimal task orientation and to interface with secondary motion systems. Positioned on one of the rotational platforms is a scissor lift (z-axis), enabling vertical displacement for the corresponding robot 412, 414. The other two robots 416, 418 utilize column lifts (z-axis) for similar vertical movement. Each robot structure includes a column lift (y-axis) mounted perpendicular to the pod floor, which provides translational movement along the Y-axis. One robot is additionally equipped with a linear actuator (secondary x-axis), mounted transversely to the primary linear path, allowing lateral continuation of motion after rotational reorientation. Each of the three robots is a dual-arm robot, wherein each arm is fitted with interchangeable end effectors. The illustrated example includes two variants: one robot with 5-fingered robot hands and others with dual grippers for high-precision or heavy-duty tasks. Situated between the arms of each robot are dedicated cameras, used for task-level visual processing such as object detection, manipulation alignment, and inspection. For broader workspace monitoring and multi-robot coordination, pod-mounted cameras 408 are installed along the upper interior of the modular frame. An onboard computer unit 406 located at the top of the frame manages processing, control logic, sensor data integration, and communication across the pod. Electrical power is supplied via a power input interface at the base of the frame, providing energy to all actuators, cameras, controllers, and end effectors.

During operation, each robot independently traverses along the X-axis using its respective linear actuator track. The rotational base allows each robot to reorient as needed, enabling seamless transitions onto the secondary x-axis actuator for additional mobility. The scissor and column lifts provide vertical range, while the y-axis column lifts allow depth adjustment. Through coordinated motion and visual feedback from the cameras, all three robots can perform complex, high-throughput tasks either collaboratively or independently, maximizing task density and workspace efficiency. FIG. 4 thus demonstrates the fully modular, multi-robot capability of the invention, showing how multiple dual-arm robots with different lift mechanisms and end effector configurations can operate within a single, reconfigurable pod frame. The layout exemplifies the core inventive principles of mobility, compactness, scalability, and visual intelligence, which define the performance and versatility of the modular robotic pod system.

In the embodiment illustrated in FIGS. 1-4, the dual-arm robot, as described, may be supported by the lifting mechanism configured to provide vertical (Z-axis) and/or depth (Y-axis) motion relative to the pod frame. Lifting mechanisms may include telescopic lifts, scissor lifts, column lifts, or other equivalent designs, each capable of delivering controlled and precise translation along the respective axis. For example, telescopic lifts may be employed where compact retraction and smooth extension are desired, scissor lifts may be selected for applications requiring high load capacity and stable elevation, and column lifts may be used where rigid vertical guidance and minimal lateral deflection are advantageous. In certain embodiments, interchangeable lifting mechanisms may be deployed within the same pod design, allowing the motion architecture to be adapted for specific payload requirements, range of motion needs, or workspace constraints without altering the fundamental pod structure. This flexibility ensures that the lifting system can be tailored to optimize reach, stability, and cycle time performance for the intended application.

Further, as illustrated in FIGS. 1-4, the modular robotic pod may be specifically engineered to fit within the footprint of existing work cells or stations originally designed for a single human operator. The pod frame, motion system, and robotic arrangement are dimensioned to occupy substantially the same floor area as a human workstation while accommodating multiple dual-arm robots within that same space. Each robot may be configured with a selectable subset of motion axes, ranging from two to five axes, including X-axis, Y-axis, Z-axis, rotational axis, and secondary X-axis, enabling the system to be tailored precisely to the operational requirements of the deployment environment. Within this constrained footprint, the system can achieve throughput and operational speeds several times greater than those attainable by a single human operator performing equivalent tasks. This compact, high-density design allows facilities to upgrade from manual to automated workflows without requiring significant reconfiguration of existing floor layouts, while delivering substantial performance gains in productivity, consistency, and task parallelization.

Thus, the present invention provides the modular robotic pod system, as illustrated in FIGS. 1-4, specifically configured to fit within a human-sized work cell or workstation originally designed for a single human operator, while enabling automation capabilities that dramatically exceed human throughput within the same compact footprint. The system comprises at least one modular pod frame configured to house one or more dual-arm robots without an upper limit, thereby allowing scalability from a single robot to a high-density, multi-robot installation depending on task requirements. Each robot is mounted on a base translatable along a primary linear rail defining an X-axis, with actuators integrated into the base for providing additional Y-axis (depth) and Z-axis (vertical) motion. The base further includes a rotational platform configured to rotate each dual-arm robot about 360 degrees, enabling full omnidirectional orientation within the pod. Upon rotation, the robot base is further engageable with a secondary linear guide aligned to the primary X-axis infrastructure, allowing continued motion in the rotated orientation and delivering full multi-directional reach without increasing the physical footprint. The motion architecture of the system is modular and configurable, permitting operation with any subset of its five available axes, such as the X-axis, Y-axis, Z-axis, rotational axis, and secondary X-axis, so that each pod may be tailored to operate with two, three, four, or all five axes depending on the requirements of a particular application. This flexibility allows cost optimization, adaptation to spatial constraints, and scalability for future upgrades while maintaining the compact design. The pod frame itself is modular and reconfigurable to support a wide range of spatial configurations, including linear, stacked, side-by-side, hybrid, U-shaped, dual-U-shaped, L-shaped, or gantry-style arrangements, thereby allowing maximum adaptability across diverse environments. Each dual-arm robot integrated within the pod may be equipped with interchangeable end effectors, such as dexterous humanoid hands, grippers, vacuum grippers, magnetic grippers, or custom-designed tools, enabling task-specific adaptability and rapid reconfiguration. One or more cameras are mounted to the pod frame to provide global workspace awareness, while each dual-arm robot is further integrated with dedicated cameras, enabling visual guidance, object recognition, task-specific alignment, quality inspection, and collision avoidance. Multiple robots within the same pod may operate independently or cooperatively, including the ability to hand off objects, perform synchronized manipulation, or execute parallel tasks within shared zones. By combining compact human-sized integration, unlimited scalability of dual-arm robots, configurable two-to-five axis modular motion, interchangeable tooling, and intelligent vision-based perception, the invention provides a transformative automation solution applicable across a wide range of industries, including but not limited to manufacturing, logistics, warehousing, healthcare, retail, and service environments. The system achieves several times the throughput and operational speed of a human operator while fitting into the same physical footprint, enabling rapid adoption of advanced automation without requiring structural modifications to existing workspaces.

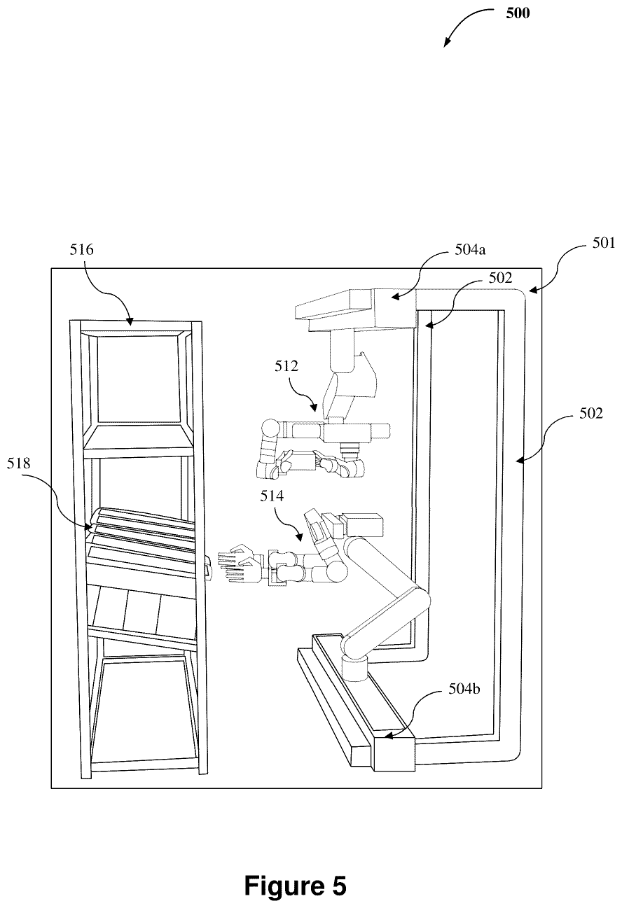

Now, FIGS. 5-8 will be described to illustrate exemplary real-world applications of the modular robotic pod system. These examples are provided solely for explanatory purposes and should not be construed as limiting the scope of the invention. The system is expressly adaptable for deployment across a wide range of industries, with the ability to accommodate varied configurations of dual-arm robots, modular frame geometries, and motion architectures depending on the operational requirements of the environment in which it is installed.

FIG. 5 illustrates an exemplary real-world application of the modular robotic pod system 501 deployed within a compact material handling and sorting station 500. This operational scenario demonstrates how the system can be integrated into an industrial or warehouse setting to automate tasks such as object retrieval, bin picking, inventory organization, or kitting, particularly in environments traditionally designed for a single human operator. In this example, the modular pod frame 502 is installed adjacent to a racking structure 516 holding multiple bins 518 angled forward for easy access. A dual-arm robot 512 or 514, supported by a vertically oriented scissor lift and mounted on a horizontal linear actuator, operates within the pod. The robot 512 or 514 is equipped with articulated end effectors (depicted here as five-fingered robotic hands), enabling it to grasp, manipulate, and transfer objects with dexterity similar to that of a human operator. The upper robot 512 has been shown accessing a storage shelf, for example, for the purpose of retrieving or depositing items, while the lower robot 514 reaches toward the tilted bin 518 positioned in a front-facing rack. This layout demonstrates how the robot's combined X, Y, Z-axis and rotational capabilities enable it to work across a three-dimensional field, allowing both vertical and lateral access to components and containers placed at varying heights and orientations. The pod system occupies a small footprint on the factory floor and is bordered by marked safety zones, indicating integration into an existing industrial layout without disruption. The figure also highlights the application of the system in scenarios requiring tight spatial efficiency, fast response time, and adaptable robot behavior. The modular pod's high-density mechanical configuration and camera-guided dexterous manipulation capabilities allow the dual-arm robot to perform coordinated tasks that would otherwise require multiple human operators or larger robotic setups. By automating bin handling, sorting, or pick-and-place operations, the system reduces cycle time, improves accuracy, and minimizes human involvement in repetitive or ergonomically strenuous tasks.

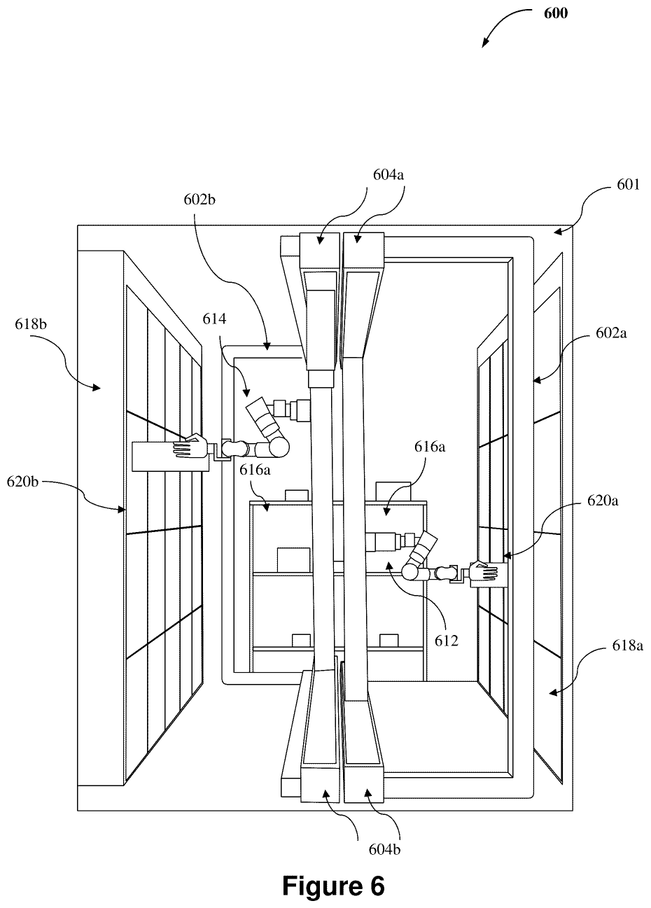

FIG. 6 illustrates an exemplary application of the modular robotic pod system 601 deployed in a high-density inventory management or order fulfillment environment, such as a warehouse or micro-fulfillment center 600. The figure highlights the system's capability to enable multiple dual-arm robots to operate simultaneously within a confined aisle space, facilitating efficient interaction with storage racks located on either side of the aisle. The figure shows two dual-arm robots 612, 614 mounted within the modular pod frame 602a, 602b, each on its own independent linear actuator rail. The robots 612, 614 are oriented back-to-back within the shared structure and are engaged in retrieving or placing boxed items from opposing shelf walls 618a, 618b. This layout clearly demonstrates the side-by-side dual-linear configuration, where two primary linear rails 604a, 604b are mounted in parallel within the same modular pod frame 602a, 602b, allowing the dual-arm robots 612, 614 to work in tandem without interfering with one another. Each robot 612, 614 is shown actively interacting with storage cubbies, using its articulated end effectors to handle individual packages. The motion enabled by the X-axis actuators allows each robot to travel horizontally along the aisle length, while integrated Y-axis and Z-axis mechanisms (column or scissor lifts) would allow the arms to reach vertically across different shelf levels and adjust their depth for accurate positioning. The use of five-fingered robotic hands as end effectors suggests a high degree of dexterity, suitable for handling a variety of package types and sizes. The modular pod frame 602a, 602b is designed to span the full length of the aisle and integrates a compact overhead cable or power routing system, as indicated by the green pathway, to deliver power and control signals to each robotic unit without floor-level obstruction. The narrow aisle width and full-height shelving on either side indicate that the pod system is optimized for space-constrained environments where maximizing vertical and horizontal storage access is critical. This application exemplifies how the modular robotic pod system 601 can automate pick-and-place operations in retail warehouses, e-commerce fulfillment hubs, or inventory restocking centers. By operating with multiple robots in parallel within the same structural pod, the system enables faster processing rates, higher task concurrency, and full utilization of shelf space while minimizing the system footprint. The vision-guided manipulators and multi-axis positioning allow the robots to perform precise inventory handling with minimal human intervention.

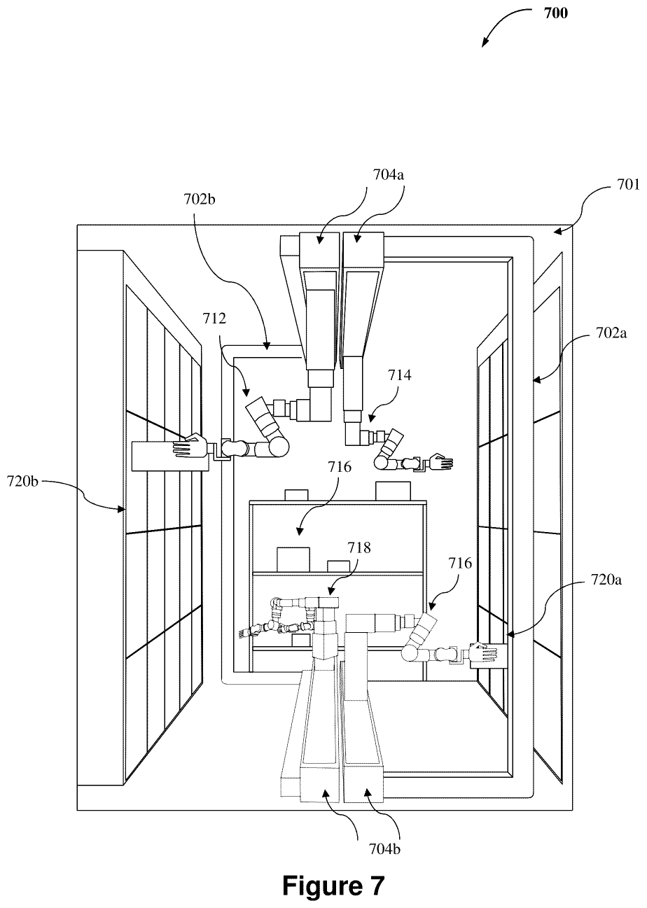

FIG. 7 illustrates an advanced exemplary application of the modular robotic pod system 701 deployed in a high-density, high-throughput inventory automation environment. This figure demonstrates a fully populated multi-robot configuration, wherein four dual-arm robotic units 712, 714, 716, 718 operate simultaneously within a single modular pod frame 702a, 702b, servicing inventory racks placed along both sides of a narrow aisle. The configuration exemplifies maximum operational density and multi-agent task execution in compact logistics or warehouse settings. The modular pod frame 702a, 702b supports dual linear actuators (X-axis) 704am 704b arranged in parallel, enabling independent translational motion for each robot along the aisle. Each robot 712, 714, 716, or 718 is mounted on a rotational base, allowing it to reorient and dynamically access shelf zones on either side. The central robot unit in this figure is additionally mounted to a scissor lift (Z-axis), granting it vertical movement for reaching higher or lower shelves that may not be accessible to the robots mounted on column lifts. Each dual-arm robot 712, 714, 716, or 718 is actively engaged in pick-and-place tasks, as evidenced by the synchronized motions of their articulated arms reaching into cubbyholes 720a, 720b and extracting or placing boxes. The end effectors, represented as anthropomorphic five-fingered robotic hands, provide high dexterity to securely handle various item shapes and sizes. This robotic configuration is ideally suited for operations such as e-commerce fulfillment, product sorting, or just-in-time order picking. The power and control routing are neatly integrated along the pod's top and side frames, as indicated by the green embedded track, ensuring uninterrupted energy delivery to all robotic and sensor modules without introducing floor-level clutter. The system's top crossbeam is mounted with pod-level vision modules (not explicitly visible but presumed to be present), enabling environmental monitoring, coordination, and safety. Each robot is also presumed to carry onboard cameras (between the arms, as shown in prior figures) for fine visual guidance during manipulation. In this exemplary deployment, the modular pod system supports concurrent operation of three robotic units within a single aisle, all of which can collaborate or function independently depending on workload distribution. The pod's architectural design, combined with its axis-specific actuators and rotational mounts, allows robots to traverse, lift, reorient, and act upon inventory in real time while avoiding physical interference with one another.

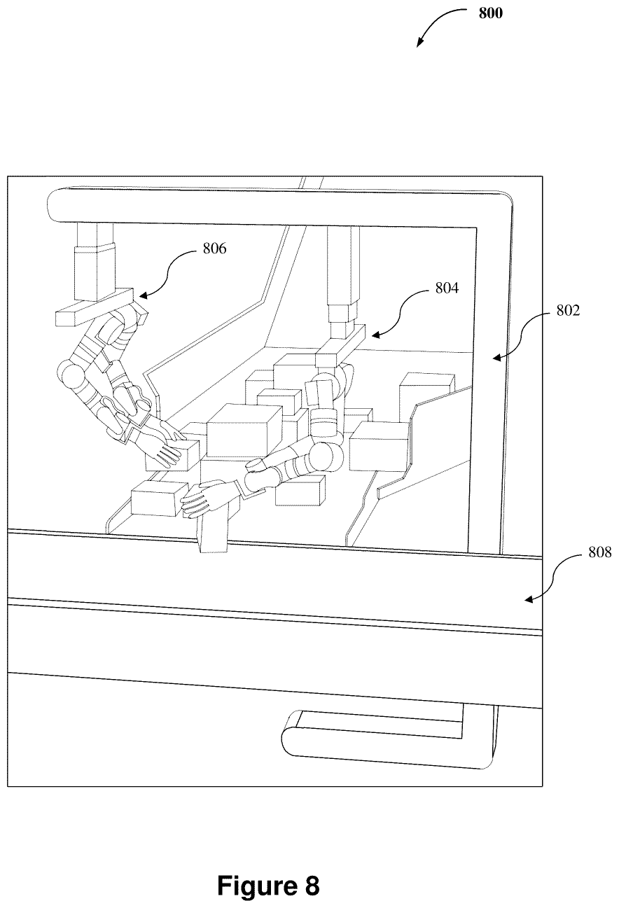

FIG. 8 illustrates an exemplary application of the modular robotic pod system 800 configured for automated parcel sorting or induction into a conveyor system, typically deployed in logistics hubs, distribution centers, or e-commerce fulfillment facilities. This example highlights the system's capability to interface directly with conveyor belts 808 and bulk material feeds to perform sorting, classification, and arrangement of packages in real time. In this embodiment, a single modular pod frame 802 houses a dual-arm robot 804, 806 suspended from the top crossbeam 802. The robot arms are shown engaging with multiple parcels of varying sizes that have been loaded onto an inclined surface or conveyor intake area. The dual arms are equipped with five-fingered end effectors, allowing them to grasp irregular or mixed-shaped parcels with high dexterity and precision. The layout is optimized for bimanual coordination, enabling the robot to manipulate, reposition, or orient multiple items simultaneously. The incoming packages may be randomly arranged or unsorted, indicating the use case of automated bin picking or random item induction. The robot's control system leverages camera vision systems (not directly visible in the frame but part of the overall invention architecture) to identify, classify, and localize each parcel. Based on this sensory input, the robot 804, 806 executes motion paths to pick and place the parcels in an organized fashion onto a downstream conveyor or into designated bins. The pod frame 802 includes an integrated power and control routing channel marked by a green strip, which supplies electrical and data connectivity to the robotic unit from a remote or embedded source. The structure is mounted above the conveyor infrastructure with a minimal floor footprint, allowing the robotic pod to be installed without interrupting the existing conveyor layout. This figure effectively demonstrates the versatility and adaptability of the modular robotic pod system when applied to parcel handling tasks. It eliminates the need for complex fixed-sorting mechanisms and replaces manual labor in high-speed, high-volume environments. The system enables dynamic sorting, error correction, object orientation, and selective induction at rates difficult to achieve through conventional means.

The modular robotic pod system presents a highly scalable, reconfigurable, and intelligent solution for high-throughput automation in confined spaces. It combines precise multi-axis motion, modular hardware architecture, collaborative control, vision-driven autonomy, and adaptive tooling support to deliver unmatched efficiency and flexibility. Its design anticipates the future of robotics-one that demands high performance, compact footprint, real-time adaptability, and seamless integration into dynamic industrial environments.

The present invention relates to a modular robotic pod system, a highly adaptable and compact automation architecture designed to house and operate one or more dual-arm robots within a reconfigurable work cell. The system is specifically engineered for deployment within spatially constrained environments, including legacy workstations originally designed for a single human operator. Despite the confined physical footprint, the system enables significant gains in throughput, efficiency, and automation capability by leveraging a modular, high-density robotic framework that supports full multi-axis motion, interchangeable tooling, and collaborative multi-robot operation. The invention facilitates transformative improvements in both static and dynamic production environments across diverse industries.

Each dual-arm robot is mounted on a mobile carriage platform configured to translate along a primary linear rail defining the X-axis. The rail serves as the main horizontal axis across the length of the pod. The robot base further comprises a 360-degree rotational platform, which allows omnidirectional reorientation. Upon rotating to a defined angle, such as 90 degrees, the robot can engage a secondary linear guide aligned to the X-axis infrastructure, thereby continuing its motion in a rotated frame of reference without increasing the pod's footprint. This configuration allows four-axis mobility (X, Y, Z, and rotation), enabling the robot to service a wider work envelope without requiring additional space or duplicated infrastructure.

The vertical (Z-axis) and depth (Y-axis) mobility are achieved through the integration of vertical and depth-oriented lift mechanisms. These include scissor lifts, column lifts, and telescopic or rail-based extensions, chosen based on payload requirements, reach, and space availability. Each lift module is controlled by integrated actuators, preferably rotary actuators with embedded motor controllers, torque sensors, and high-resolution encoders. These modules provide smooth, high-speed motion with minimal backlash and are mounted to the carriage or structure to enable accurate and stable 3D positioning of the dual-arm robot.

The modular pod frame itself is fully reconfigurable and expandable. It can support a variety of spatial arrangements including: linear configurations, where robots are aligned along a single X-axis rail; stacked configurations, where a second rail is vertically aligned above the first; side-by-side configurations, with robots mounted in parallel rails to operate back-to-back or in adjacent zones; and hybrid configurations, combining vertical and horizontal layouts to support up to four or more dual-arm robots within a single pod. Moreover, the frame can be adapted to custom geometries such as U-shaped, dual-U, L-shaped, or gantry-style configurations based on application-specific constraints or workflow designs. This flexibility allows integrators to match the robot arrangement to the desired task density, operator layout, or industrial floorplan without redesigning the underlying infrastructure.

The system is designed to fit into compact work cells, typically those that were intended for human operators, without compromising functionality or reach. Despite space constraints, each robot is capable of full multi-axis mobility and equipped to execute high-speed, high-precision operations. The system may also scale to larger multi-operator workstations or custom-built pods, allowing for uniform deployment across an entire factory floor or production environment. The pod layout ensures that robotic arms do not interfere with one another, even when multiple robots are operating in shared zones, thanks to collaborative planning logic, shared spatial awareness, and integrated sensing systems.

To enable diverse functionality, each dual-arm robot is designed with interchangeable end effectors. The system supports multiple tool types, including 5-finger humanoid hands for dexterous manipulation, 3-finger adaptive grippers, parallel or dual grippers for object retention or inter-arm transfer, vacuum grippers for pick-and-place operations, magnetic grippers for metallic components, and custom tooling tailored to packaging, folding, scanning, or labeling tasks. Tools can be swapped manually or automatically via tool changers, enabling dynamic reconfiguration of the work cell without interrupting operations.

The motion system is driven by precision linear actuators, which may include ball screws, belt drives, or rotary drives, combined with linear guides and sliders for low-friction translation. Each robot base integrates limit switches and proximity sensors to define motion bounds, detect collisions, or execute homing sequences. The entire motion subsystem is managed by a central onboard edge AI computer, which handles real-time control, motion planning, sensor integration, and robot coordination logic for all robots within the pod. The computing unit runs a full software stack, including a robot control framework, multi-robot coordination layer, vision processing pipeline, tool control module, and system health monitoring suite for safe, autonomous operation.

The cameras and perception sensors are distributed throughout the system to provide real-time environmental feedback. Each dual-arm robot includes a primary camera module located between the arms, which acts as the robot's “head” vision system. Additional cameras may be mounted directly on the end effectors for close-range manipulation and grasp confirmation. The pod frame itself is fitted with wide-angle or depth cameras to provide a global view of the shared workspace and identify humans, objects, or other robots in proximity. These camera systems collect RGB and depth data to perform at least one of object recognition, scene understanding, alignment tracking, or motion correction, but should not be construed as limiting to the scope of the present invention. Real-time perception enables collision avoidance, object targeting, and cooperative behaviors between multiple robots.

Collision avoidance is implemented through a layered system combining visual sensing, real-time kinematic tracking, and predictive motion planning. Sterco or depth vision data is processed to detect workspace boundaries, nearby robotic elements, or foreign objects. Dynamic motion control ensures that no part of a robot collides with its own structure, with other robots within the pod, or with surrounding objects such as racks, shelves, or bins. Failsafe mechanisms include proximity slow-down zones, emergency stop triggers, and trajectory resampling to guarantee safety during simultaneous multi-robot operations.

The pod system supports both tethered power configurations, suitable for fixed installations connected to a facility supply, and modular battery power packs, which can be swapped for untethered or mobile deployments. The power distribution module ensures regulated voltage delivery to all subsystems and protects against overload, under-voltage, or short-circuit conditions. Power and data are routed through dedicated communication buses, such as CAN or Ethernet, to minimize latency and ensure robust coordination across sensors, motors, and controllers.

In terms of software capabilities, the system supports multi-robot coordination, allowing up to four or more dual-arm robots within the same pod to collaborate on multi-stage workflows. Each robot maintains real-time kinematic awareness of the other units, enabling item handoffs, co-manipulation, and task sequencing. For example, one robot may pick and position a part, which is then assembled or scanned by a second robot. Shared control logic and central planning prevent deadlocks or motion conflicts during such cooperative tasks, ensuring efficiency and synchronization.

The pod can optionally be operated using voice-based interfaces, particularly beneficial during testing, training, or supervised modes. The system includes integrated voice recognition modules that respond to wake words, interpret commands such as “pause operation” or “switch tool,” and map them to robot actions via onboard processing. This enables hands-free operation, particularly useful in environments requiring rapid iteration or human-robot interaction.

The system supports a wide range of real-world deployments, including but not limited to: inventory handling, warehouse order fulfillment, pick-and-place sorting, material loading and unloading, assembly line tasks, micro-fulfillment operations, and conveyor-based parcel induction. It can be installed between opposing racks for dual-sided access, integrated into legacy human work cells, placed above conveyors for real-time sorting, or configured in dense aisle-based arrangements for maximum throughput. The system's modular nature allows deployment in single-pod or multi-pod arrangements depending on production volume, spatial constraints, and functional requirements.

The foregoing descriptions of specific embodiments of the present technology have been presented for purposes of illustration and description. They are not intended to be exhaustive or to limit the present technology to the precise forms disclosed, and obviously many modifications and variations are possible considering the above teaching. The embodiments were chosen and described to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

What is claimed is:

1. A modular robotic pod system comprising:
at least one pod frame configured to house one or more dual-arm robots;
at least one primary linear rail defining an X-axis;
at least one robot base mounted to the primary linear rail, the robot base including actuators configured to provide motion along a Y-axis and a Z-axis, and a rotational platform configured to rotate each dual-arm robot about 360 degrees,
wherein, upon the rotation, the robot base is engageable with a secondary linear guide enabling continued motion along the X-axis, and
wherein the pod frame is modular and reconfigurable to support multiple spatial configurations for accommodating varying numbers of robots within a workspace.

2. The modular robotic pod system of claim 1, wherein the pod frame is configurable in at least one of a linear configuration, vertically stacked configuration, side-by-side configuration, hybrid configuration, U-shaped configuration, dual-U-shaped configuration, or gantry-style configuration.

3. The modular robotic pod system of claim 1, wherein the pod frame is expandable to increase robot density without increasing the overall footprint, and wherein the robot base is configured to move along the primary linear rail while maintaining operational stability during motion.

4. The modular robotic pod system of claim 1, wherein the dual-arm robot includes interchangeable end effectors adapted for task-specific operations.

5. The modular robotic pod system of claim 1, wherein the secondary linear guide is aligned to permit uninterrupted motion of the robot base following the rotation, and wherein the pod frame and robots are arranged to enable collaborative operation between multiple robots within the same workspace.

6. The modular robotic pod system of claim 1, further comprising one or more cameras mounted to the pod frame for monitoring the workspace and robot operations.

7. The modular robotic pod system of claim 6, wherein each of the one or more dual-arm robots is integrated with a dedicated camera for task-specific visual guidance, and wherein each dedicated camera is configured to provide real-time visual feedback to an onboard computer unit for positioning and task execution.

8. The modular robotic pod system of claim 6, wherein the one or more cameras are configured to perform at least one of object recognition, quality inspection, or motion tracking within the same workspace.

9. The modular robotic pod system of claim 6, wherein the cameras are configured to detect obstacles and dynamically adjust robot paths to prevent collisions, and wherein the dedicated camera for each robot is mounted to provide a field of view encompassing both arms of the robot.

10. The modular robotic pod system of claim 1, wherein the rotational platform is operable to rotate the dual-arm robot to predefined angular positions for task alignment.

11. The modular robotic pod system of claim 1, wherein the actuators are configured to provide synchronized X, Y, and Z-axis motion to coordinate multi-axis positioning.

12. The modular robotic pod system of claim 1, wherein the pod frame is designed to integrate into human-sized work cell or workstation.

13. The modular robotic pod system of claim 1, wherein the primary linear rail and secondary linear guide share a common support structure to minimize floor space usage.

14. The modular robotic pod system of claim 1, wherein the pod frame is constructed from modular segments that are connectable in multiple orientations to form a desired pod geometry.

15. A modular robotic pod system configured to fit within a human-sized work cell or workstation, the system comprising:
at least one pod frame configured to house one or more dual-arm robots without an upper limit;
at least one primary linear rail defining an X-axis;
at least one robot base mounted to the primary linear rail, the robot base including actuators configured to provide motion along a Y-axis and a Z-axis, and a rotational platform configured to rotate each dual-arm robot about 360 degrees;
wherein, upon the rotation, the robot base is engageable with a secondary linear guide enabling continued motion along the X-axis; and
wherein the pod frame is modular and reconfigurable to support multiple spatial configurations, and the system is configurable to operate with any subset of two to five motion axes selected from the X-axis, Y-axis, Z-axis, rotational axis, and secondary X-axis, thereby accommodating varying numbers of robots and tasks within the same compact footprint.

16. The modular robotic pod system of claim 15, wherein the secondary linear guide is operable only when the robot base is rotated, thereby enabling full multi-directional reach within the same footprint.

17. The modular robotic pod system of claim 15, wherein the pod frame is reconfigurable into one or more of a linear, stacked, side-by-side, hybrid, U-shaped, dual-U-shaped, L-shaped, or gantry-style configuration to optimize workspace efficiency.

18. The modular robotic pod system of claim 15, wherein each dual-arm robot is equipped with interchangeable end effectors selected from dexterous humanoid hands, grippers, vacuum grippers, magnetic grippers, or custom-designed tools for task-specific operations.

19. The modular robotic pod system of claim 15, further comprising one or more cameras mounted to the pod frame and one or more cameras integrated with each dual-arm robot, the cameras configured to provide workspace monitoring, object recognition, quality inspection, and collision avoidance.

20. The modular robotic pod system of claim 1, wherein multiple dual-arm robots housed within the same pod frame are configured to operate cooperatively or independently to execute shared tasks, perform object handoffs, or carry out parallel operations across a range of industrial, commercial, and service applications.
